(19) United States
(12) Patent Application Publication
(10) Pub. No.: US 2024/0396402 A1
(43) Pub. Date: Nov. 28, 2024

(54) DIESEL GENERATOR CONTAINER WITH INTEGRATED WIRING HARNESS INTERFACE

(71) Applicant: Hebei Qinhuai Data Co., Limited., Zhangjiakou City (CN)

(72) Inventor: Binghua ZHANG, Zhangjiakou City, Hebei Province (CN)

(21) Appl. No.: 18/664,530

(22) Filed: May 15, 2024

(30) Foreign Application Priority Data
May 24, 2023 (CN) 202310589452.7

(51) Int. Cl. H02K 5/22; F02B 63/04; H01B 7/00; H02K 7/18; H02K 11/30

(52) U.S. Cl. CPC H02K 5/225; H02K 7/1815; H02K 11/30; F02B 63/04; H01B 7/0045

(57) ABSTRACT

The present disclosure discloses a diesel generator container with an integrated wiring harness interface, including a control box, a first container, a second container, a diesel generator parallel cabinet, a first sensor rod, a second sensor rod, and a third sensor rod. The control box is internally provided with a controller. The control box, the first container, the second container, and the diesel generator parallel cabinet are separately provided with a plurality of female connectors. Two ends of the first sensor rod, of the second sensor rod, and of the third sensor rod are separately provided with male connectors.

### CROSS REFERENCE TO RELATED APPLICATION

This application claims priority to Chinese Patent Application No. 202310589452.7, titled “DIESEL GENERATOR CONTAINER WITH INTEGRATED WIRING HARNESS INTERFACE” and filed to the China National Intellectual Property Administration on May 24, 2023, the entire contents of which are incorporated herein by reference.

### TECHNICAL FIELD

The present disclosure relates to the field of diesel generator container, and more particularly, to a diesel generator container with an integrated wiring harness interface.

### BACKGROUND

Considering that huge workload of on-site cabling of secondary wires in the diesel generator system container may rely heavily on technical personnel and skilled secondary wiring workers, a large amount of engineering work in different projects can neither achieve engineering replication nor ensure engineering quality. In production wiring processes, when on-site wiring personnel need to connect wiring harnesses to distribution network automation cabinets, in most cases there are wiring errors, and even attenuation during signal transmission, resulting in inaccurate information collection.

### SUMMARY

The present disclosure provides a diesel generator container with an integrated wiring harness interface, aiming to solve a problem of easy wiring errors caused by manual wiring.

According to an embodiment of the present disclosure, there is provided a diesel generator container with an integrated wiring harness interface, including a control box, a first container, a second container, a diesel generator parallel cabinet, a first sensor rod, a second sensor rod, and a third sensor rod. The control box is internally provided with a controller. The control box, the first container, the second container, and the diesel generator parallel cabinet are separately provided with a plurality of female connectors. Two ends of the first sensor rod, of the second sensor rod, and of the third sensor rod are separately provided with male connectors. The female connectors on the control box are plugged into the male connectors on the first sensor rod, the male connectors on the first sensor rod are plugged into the female connectors on the first container, the female connectors on the first container are plugged into the male connectors on the second sensor rod, the male connectors on the second sensor rod are plugged into the female connectors on the second container, the female connectors on the control box are plugged into the male connectors on the third sensor rod, and the male connectors on the third sensor rod are plugged into the female connectors on the diesel generator parallel cabinet. A top and a bottom of the first sensor rod, of the second sensor rod, and of the third sensor rod are sealed with a sealant.

In the diesel generator container with the integrated wiring harness interface of the present disclosure, 50 wiring harnesses are separately arranged inside the first sensor rod, inside the second sensor rod, and inside the third sensor rod. Each of the wiring harnesses has a cross-sectional area of 0.3 square millimeters.

In the diesel generator container with the integrated wiring harness interface of the present disclosure, the wiring harness and a wiring harness of a sensor are converged onto a signal processing transmitter connected to a top end of the sensor rod.

In the diesel generator container with the integrated wiring harness interface of the present disclosure, the wiring harness includes a first set of cables and a second set of cables. One end of the first and second sets of cables is jointly connected to a first terminal connector, other end of the first set of cables is connected to a second terminal connector, and other end of the second set of cables is connected to a third terminal connector. The first terminal connector includes a plastic shell comprised of a front-end circular plug and a tail-end square tailstock, and the circular plug is internally provided with a USBA-TYPE socket and a USBB-TYPE socket.

In the diesel generator container with the integrated wiring harness interface of the present disclosure, the second terminal connector and the third terminal connector have a same structure. A quad cable core extends from the other end of the first set of cables, the quad cable core is connected to a plug-in terminal, and the plug-in terminal is connected to the second terminal connector. Similarly, a quad cable core extends from the other end of the second set of cables, the quad cable core is connected to a plug-in terminal, and the plug-in terminal is connected to the third terminal connector.

In the diesel generator container with the integrated wiring harness interface of the present disclosure, the cable and the cable core are gathered inside the sensor rods together with a heat shrink sleeve, and are correspondingly connected to an aviation plug female connector and an aviation plug male connector, respectively. All secondary wires are integrated into the aviation plug female connector inside the container.

The technical solutions provided by the embodiments of the present disclosure may include following beneficial effects.

Considering that huge workload of on-site cabling of secondary wires in the diesel generator system container may rely heavily on technical personnel and skilled secondary wiring workers, dozens to hundreds of control wires may be required. However, too many wires may lead to a consequence that the cabling is very messy, which brings trouble for the cabling and brings inconvenience for follow-up maintenance. Based on productization integration of wiring harnesses, on-site workers only need to insert the wiring harnesses on a side of a medium voltage cabinet in the diesel generator container in contrast with number of the wiring harnesses. In this way, connection of the secondary wires may be completed.

### BRIEF DESCRIPTION OF THE DRAWINGS

To describe the technical solutions of the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a schematic diagram of an overall structure according to the present disclosure;

FIG. 2 is a schematic diagram of a sensor rod in FIG. 1 according to the present disclosure; and

FIG. 3 is a schematic diagram of a female connector in FIG. 1 according to the present disclosure.

### REFERENCE NUMERALS IN THE ACCOMPANYING DRAWINGS

control box 1; controller 2; female connector 3; first sensor rod 4; male connector 5; first container 6; second sensor rod 7; second container 8; diesel generator parallel cabinet 9; and third sensor rod 10.

### DETAILED DESCRIPTION

Technical solutions in the embodiments of the present disclosure will be described clearly and completely below, in conjunction with the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

It should also be understood that the terms used in this specification of the present disclosure are only for the purpose of describing particular embodiments and are not intended to limit the present disclosure. As used in the specification and the appended claims of the present disclosure, the singular forms of “a”, “an” and “the” may be intended to include the plural forms, unless the context clearly indicates otherwise.

It should also be further understood that the term “and/or” used in the specification and the appended claims of the present disclosure refers to any combination of one or more of the relevantly listed items and all possible combinations, and includes these combinations.

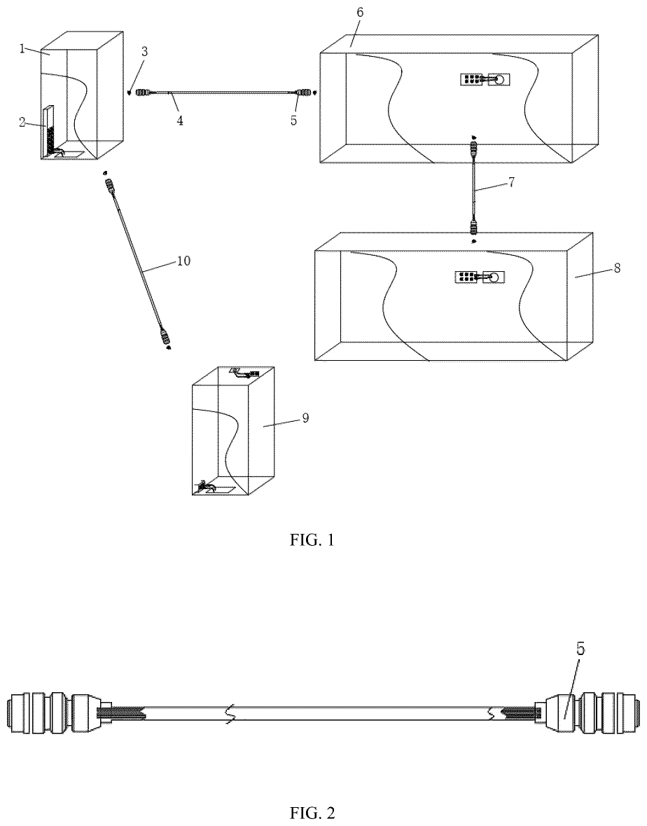

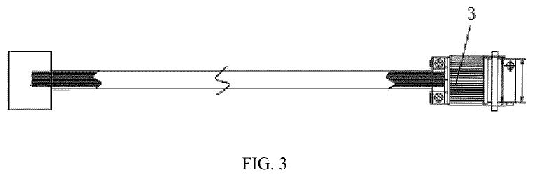

Referring to FIGS. 1 to 3, a diesel generator container with an integrated wiring harness interface includes a control box 1, a first container 6, a second container 8, a diesel generator parallel cabinet 9, a first sensor rod 4, a second sensor rod 7, and a third sensor rod 10. The control box 1 is internally provided with a controller 2. The control box 1, the first container 6, the second container 8, and the diesel generator parallel cabinet 9 are separately provided with a plurality of female connectors 3. Two ends of the first sensor rod 4, of the second sensor rod 7, and of the third sensor rod 10 are separately provided with male connectors 5. 50 wiring harnesses are separately arranged inside the first sensor rod 4, inside the second sensor rod 7, and inside the third sensor rod 10. Each of the wiring harnesses has a cross-sectional area of 0.3 square millimeters.

Referring to FIGS. 1 to 3, the wiring harness and a wiring harness of a sensor are converged onto a signal processing transmitter connected to a top end of the sensor rod. The wiring harness includes a first set of cables and a second set of cables. One end of the first and second sets of cables is jointly connected to a first terminal connector, other end of the first set of cables is connected to a second terminal connector, and other end of the second set of cables is connected to a third terminal connector. The first terminal connector includes a plastic shell comprised of a front-end circular plug and a tail-end square tailstock, and the circular plug is internally provided with a USBA-TYPE socket and a USBB-TYPE socket. Based on three cable types, i.e. AC signal wires, DC signal wires and shielded signal wires, all secondary wires are classified into red shielded control harnesses, cyan control harnesses, and yellow control harnesses. The shielded control harnesses shield all control wires, the shielded control harnesses integrate all the shielded control harnesses, the cyan control harnesses integrate all the cyan control harnesses, and the yellow control harnesses integrate all the yellow control harnesses for differentiation during production. The second terminal connector and the third terminal connector have a same structure. A quad cable core extends from the other end of the first set of cables, the quad cable core is connected to a plug-in terminal, and the plug-in terminal is connected to the second terminal connector. Similarly, a quad cable core extends from the other end of the second set of cables, the quad cable core is connected to a plug-in terminal, and the plug-in terminal is connected to the third terminal connector. The cable and the cable core are gathered inside the sensor rods together with a heat shrink sleeve, and are correspondingly connected to an aviation plug female connector 3 and an aviation plug male connector 5, respectively. All the secondary wires are integrated into the aviation plug female connector 3 inside the container.

Referring to FIGS. 1 to 3, the female connectors 3 on the control box 1 are plugged into the male connectors 5 on the first sensor rod 4, the male connectors 5 on the first sensor rod 4 are plugged into the female connectors 3 on the first container 6, the female connectors 3 on the first container 6 are plugged into the male connectors 5 on the second sensor rod 7, the male connectors 5 on the second sensor rod 7 are plugged into the female connectors 3 on the second container 8, the female connectors 3 on the control box 1 are plugged into the male connectors 5 on the third sensor rod 10, and the male connectors 5 on the third sensor rod 10 are plugged into the female connectors 3 on the diesel generator parallel cabinet 9. A top and a bottom of the first sensor rod 4, of the second sensor rod 7, and of the third sensor rod 10 are sealed with a sealant.

Specific implementation processes of the present disclosure are as follows. Connection between the control box 1 and the first container 6 may be achieved by plugging the male connectors 5 into the female connectors 3. Connection between the first container 6 and the second container 8 may be achieved by plugging the male connectors 5 into the female connectors 3. Connection between the first control box 1 and the diesel generator parallel cabinet 9 may be achieved by plugging the male connectors 5 into the female connectors 3. Considering that huge workload of on-site cabling of the secondary wires in the diesel generator system container may rely heavily on technical personnel and skilled secondary wiring workers, dozens to hundreds of control wires may be required. However, too many wires may lead to a consequence that the cabling is very messy, which brings trouble for the cabling and brings inconvenience for follow-up maintenance. Based on productization integration of the wiring harnesses, on-site workers only need to insert the wiring harnesses on a side of a medium voltage cabinet in the diesel generator container in contrast with number of the wiring harnesses. In this way, connection of the secondary wires may be completed.

The preceding descriptions are merely specific embodiments of the present disclosure, but are not intended to limit the protection scope of the present disclosure. Various equivalent modifications or replacements may be easily thought of by any person skilled in the art without departing from the technical scope disclosed by the present disclosure, and these modifications or replacements shall all fall within the protection scope of the present disclosure. Therefore, the protection scope of the present disclosure shall be subject to that of the claims.

What is claimed is:

1. A diesel generator container with an integrated wiring harness interface, comprising a control box, a first container, a second container, a diesel generator parallel cabinet, a first sensor rod, a second sensor rod, and a third sensor rod, wherein the control box is internally provided with a controller; the control box, the first container, the second container, and the diesel generator parallel cabinet are separately provided with a plurality of female connectors; two ends of the first sensor rod, of the second sensor rod and of the third sensor rod are separately provided with male connectors; the female connectors on the control box are plugged into the male connectors on the first sensor rod, the male connectors on the first sensor rod are plugged into the female connectors on the first container, the female connectors on the first container are plugged into the male connectors on the second sensor rod, the male connectors on the second sensor rod are connected to the female connectors on the second container, the female connectors on the control box are plugged into the male connectors on the third sensor rod, and the male connectors on the third sensor rod are plugged into the female connectors on the diesel generator parallel cabinet; and a top and a bottom of the first sensor rod, of the second sensor rod, and of the third sensor rod are sealed with a sealant.

2. The diesel generator container with the integrated wiring harness interface according to claim 1, wherein 50 wiring harnesses are separately arranged inside the first sensor rod, inside the second sensor rod, and inside the third sensor rod, each of the wiring harnesses having a cross-sectional area of 0.3 square millimeters.

3. The diesel generator container with the integrated wiring harness interface according to claim 1, wherein the wiring harness and a wiring harness of a sensor are converged onto a signal processing transmitter connected to a top end of the sensor rod.

4. The diesel generator container with the integrated wiring harness interface according to claim 2, wherein the wiring harness comprises a first set of cables and a second set of cables, one end of the first and second sets of cables is jointly connected to a first terminal connector, other end of the first set of cables is connected to a second terminal connector, and other end of the second set of cables is connected to a third terminal connector; the first terminal connector comprises a plastic shell comprised of a front-end circular plug and a tail-end square tailstock, and the circular plug is internally provided with a USBA-TYPE socket and a USBB-TYPE socket.

5. The diesel generator container with the integrated wiring harness interface according to claim 4, wherein the second terminal connector and the third terminal connector have a same structure; a quad cable core extends from the other end of the first set of cables, the quad cable core is connected to a plug-in terminal, and the plug-in terminal is connected to the second terminal connector; and similarly, a quad cable core extends from the other end of the second set of cables, the quad cable core is connected to a plug-in terminal, and the plug-in terminal is connected to the third terminal connector.

6. The diesel generator container with the integrated wiring harness interface according to claim 1, wherein the cable and the cable core are gathered inside the sensor rods together with a heat shrink sleeve, and are correspondingly connected to an aviation plug female connector and an aviation plug male connector, respectively; and all secondary wires are integrated into the aviation plug female connector inside the container.
